(19) United States
(12) Patent Application Publication
(10) Pub. No.: US 2017/0347407 A1
(43) Pub. Date: Nov. 30, 2017

(54) Electric Induction Edge Heating of Electrically Conductive Slabs

(71) Applicant: Inductotherm Corp., Rancocas, NJ (US)

(72) Inventor: Vitaly A. PEYSAKHOVICH, Staten Island, NY (US)

(21) Appl. No.: 15/680,930

(22) Filed: Aug. 18, 2017

Related U.S. Application Data
(62) Division of application No. 12/509,458, filed on Jul. 25, 2009.
(60) Provisional application No. 61/083,547, filed on Jul. 25, 2008.

(51) Int. Cl. H05B 6/36; H05B 6/40

(52) U.S. Cl. CPC H05B 6/365; H05B 6/40

(57) ABSTRACT

Electric induction heating of the edges of a slab comprising an electrically conductive, non-ferrous material is achieved with a transverse flux induction coil that comprises a pair of coil sections with the slab passing between the coil sections. The coil sections extend transversely beyond the opposing edges of the slab. Magnetic flux concentrators are positioned around regions of the coil sections that are above and below the slab. An electrically conductive compensator is inserted between each of the two opposing extended ends of the coils sections in the vicinity of an edge of the slab. Alternatively only one of the edges of the slab may be inductively heated.

### CROSS REFERENCE TO RELATED APPLICATIONS

This is a divisional application of application Ser. No. 12/509,458, filed Jul. 25, 2009, which application claims the benefit of U.S. Provisional Application No. 61/083,547, filed Jul. 25, 2008, both of which applications are hereby incorporated by reference in their entireties.

### FIELD OF THE INVENTION

The present invention relates to electric induction edge heating of slabs formed from an electrically conductive, non-ferrous material.

### BACKGROUND OF THE INVENTION

A typical conventional transverse flux inductor comprises an induction coil having two sections. An electrically conductive sheet material, either continuous, or of discrete lengths, can be inductively heated along its cross section by: placing the material between the two sections of the coil; supplying ac current to the coil; and moving the material through the two sections of the coil. For example, in FIG. 1, the induction coil comprises coil section 101 and coil section 103, located respectively above and below the material, which may be, for example, metal strip 90, which moves continuously through the coil in the direction illustrated by the arrow. For orientation, a three-dimension orthogonal space is defined by the X, Y and Z axes shown in FIG. 1. Accordingly the strip moves in the X direction. The gap, g_{c}, or opening, between the coil sections is exaggerated in the figure for clarity, but is fixed in length across the cross section of the strip. Terminals 101a and 101b of coil section 101, and terminals 103a and 103b of coil section 103, are connected to one or more suitable ac power sources (not shown in the figures) with instantaneous current polarities as indicated in the figure. Current flow through the coil creates a common magnetic flux, as illustrated by typical flux line 105 (illustrated by dashed line), that passes perpendicularly through the strip to induce eddy currents in the plane of the strip. Magnetic flux concentrators 117 (partially shown around coil section 101 in the figure), for example, laminations or other high permeability, low reluctance materials, may be used to direct the magnetic field towards the strip. Selection of the ac current frequency (f, in Hertz) for efficient induced heating is given by the equation:

$$f = 2 \times {10}^{6} \frac{ρ \cdot {g}_{c}}{{τ}^{2} \cdot {d}_{s}}$$

where ρ is the electrical resistivity of the strip measured in Ωm; g_{c} is the gap (opening) between the coil sections measured in meters; τ is the pole pitch (step) of the coil measured in meters; and dₛ is the thickness of the strip measured in meters.

FIG. 2 illustrates a typical cross sectional strip heating profile obtained with the arrangement in FIG. 1 when the pole pitch of the coil is relatively small and, from the above equation, the frequency is correspondingly low. The X-axis in FIG. 2 represents the normalized cross sectional coordinate of the strip with the center of the strip being coordinate 0.0, and the opposing edges of the strip being coordinates +1.0 and −1.0. The Y-axis represents the normalized temperature achieved from induction heating of the strip with normalized temperature 1.0 representing the generally uniform heated temperature across middle region 111 of the strip. Nearer to the edges of the strip, in regions 113 (referred to as the shoulder regions), the cross sectional induced temperatures of the strip decrease from the normalized temperature value of 1.0, and then increase in edge regions 115 of the strip to above the normalized temperature value of 1.0.

In some multi-step industrial processes the material is initially heated and then transferred to a second process step. In transit from initial heating to the second process step, the edges of the material may significantly cool. Consequently some type of edge heating of the material must be accomplished between the initial heating of the material and the second process step.

Relative to electric induction heating, a strip may be defined as a sheet material that is inductively heated in a process where the standard depth of penetration of the eddy current induced in the material is less than the thickness of the material. Conversely a slab may be defined as a sheet material that is inductively heated in a process where the standard depth of penetration of the eddy current induced in the material is greater than the thickness of the material. The technical approach to inductively heating the edges of a sheet material can be different depending upon whether the material is a strip or slab.

It is one object of the present invention to provide apparatus for, and method of, edge heating of an electrically conductive slab material by utilizing a transverse flux induction coil in a non-conventional manner wherein induced heating is concentrated at the edges of the slab as opposed to being more evenly distributed across the transverse width of the slab.

### BRIEF DESCRIPTION OF THE INVENTION

In one aspect, the present invention is an apparatus for, and method of, electric induction heating of the edges of an electrically conductive slab material with a transverse flux coil by extending the transverse ends of the coil beyond the opposing edges of the slab and inserting a flux compensator in the region between the extended sections of the coil adjacent to each of the opposing edges.

In another aspect, the present invention is a slab edge inductive heating apparatus for, and method of, inductively heating at least one transverse edge of a slab of an electrically conductive material. A pair of transverse flux coil sections is provided. Each one of the pair of transverse flux coil sections has a pair of transverse coil segments. Each of the pair of transverse coils segments of one of the pair of transverse flux coil sections is spaced apart from the pair of transverse coil segments of the other one of the pair of transverse flux coil sections to form a slab induction heating region through which the slab can pass with the length of the slab oriented substantially normal to the pair of transverse coil segments of each one of the pair of transverse flux coil sections. The transverse coil segments for each one of the pair of transverse flux coil sections are co-planarly separated from each other by a coil pitch distance. The transverse coil segments of each one of the pair of transverse flux coil sections have extended transverse ends that extend transversely beyond the at least one edge of the slab in the slab induction heating region. The extended transverse ends of the transverse coil segments of each one of the pair of transverse flux coil sections are connected together by a separate longitudinal coil segment oriented substantially parallel to the length of the slab in the slab induction heating region. The extended transverse ends of each pair of transverse coil segments and the longitudinal coil segment form an edge compensator region between the extended transverse ends and the longitudinal coil segment of each one of the pair of transverse flux coil sections. At least one magnetic flux concentrator surrounds at least the transverse coil segments of the pair of transverse flux coil sections substantially in all directions facing away from the slab induction heating region. At least one alternating current power source is connected to the pair of transverse flux coil sections so that an instantaneous current flows in the same direction through each one of the pair of transverse flux coil sections. Each one of the at least one alternating current power sources has an output frequency, f_{slab}, determined according to the following equation:

$${f}_{slab} > 0.5 \cdot {10}^{7} \cdot ( \frac{{ρ}_{slab}}{{d}_{slab}^{2}} )$$

where ρ_{slab} is the electrical resistivity of the slab and d_{slab} is the thickness of the slab. An electrically conductive compensator is disposed within the edge compensator region.

These and other aspects of the invention are set forth in this specification and the appended claims.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 illustrates a prior art transverse flux inductor arrangement.

FIG. 2 graphically illustrates typical cross sectional induced heating characteristics for the transverse flux inductor arrangement shown in FIG. 1.

FIG. 3 is a top plan view of one example of a slab edge inductive heating apparatus of the present invention wherein only the top section of the transverse flux induction coil is visible.

FIG. 4(a) is an elevational view through line A-A in FIG. 3 of the slab edge inductive heating apparatus shown in FIG. 3.

FIG. 4(b) is an elevational view through line B-B in FIG. 3 of the slab edge inductive heating apparatus shown in FIG. 3 with one example of connections to a power supply.

FIG. 4(c) is an isometric view of one example of a flux compensator used in the slab edge inductive heating apparatus shown in FIG. 3.

FIG. 4(d) is an elevational view through line C-C in FIG. 3 of the slab edge inductive heating apparatus shown in FIG. 3.

FIG. 5 graphically illustrates typical cross sectional induced heating characteristics for the transverse flux inductor arrangement shown in FIG. 3, FIG. 4(a), FIG. 4(b), FIG. 4(c) and FIG. 4(d).

FIG. 6(a) illustrates the advantage of using a transverse flux inductor having transverse ends extending beyond the edges of a slab over a transverse flux coil with transverse ends located near the edges of a sheet material as shown in FIG. 6(b).

FIG. 7(a) illustrates the advantageous representative flux field achieved in the present invention over the representative flux field achieved in the prior art as illustrated in FIG. 7(b).

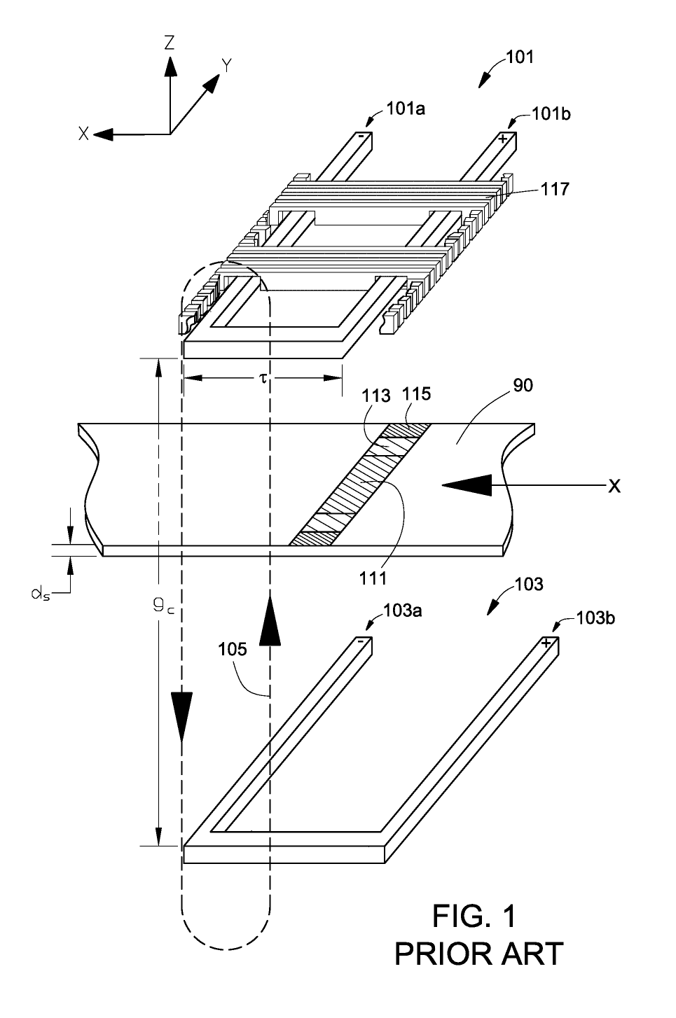

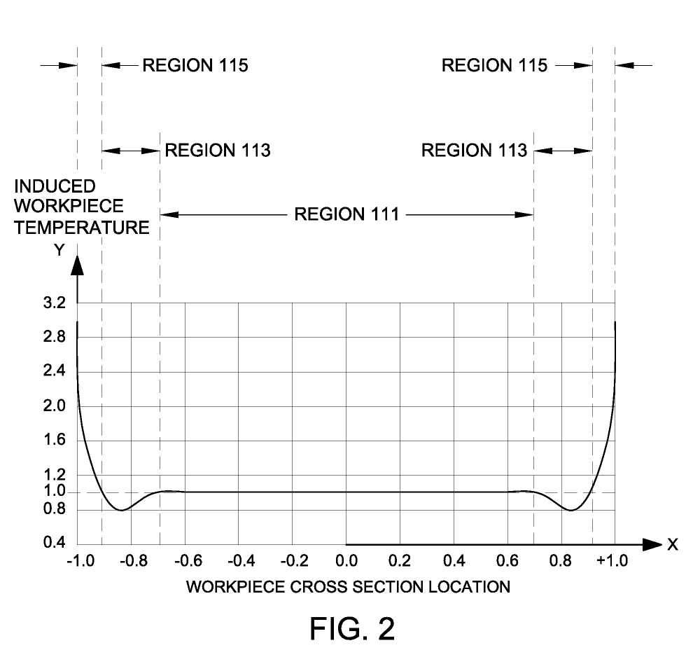

### DETAILED DESCRIPTION OF THE INVENTION

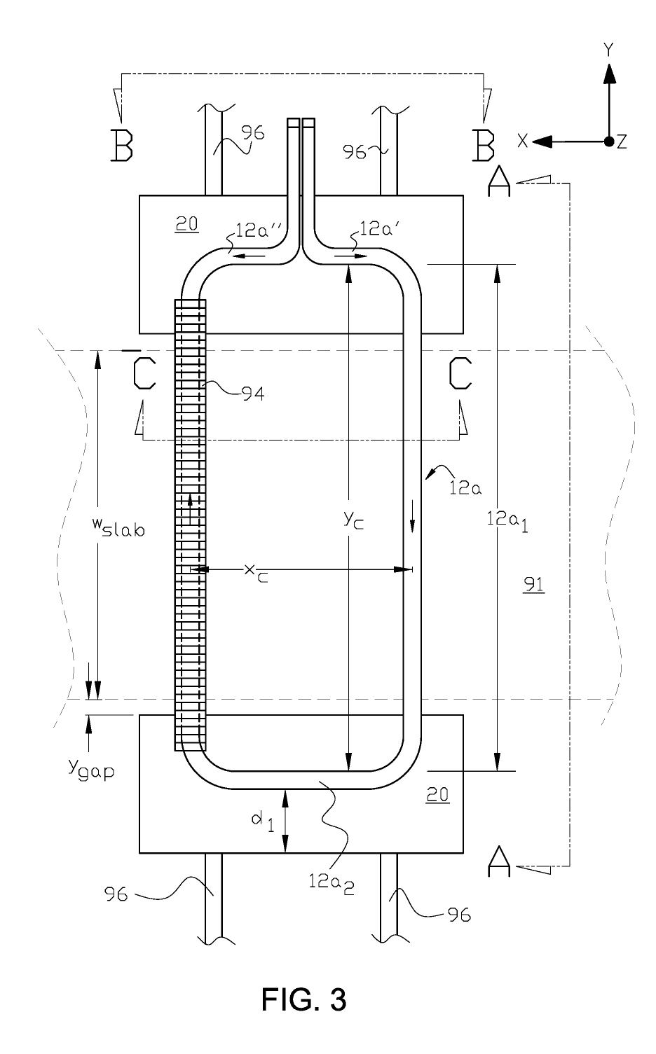

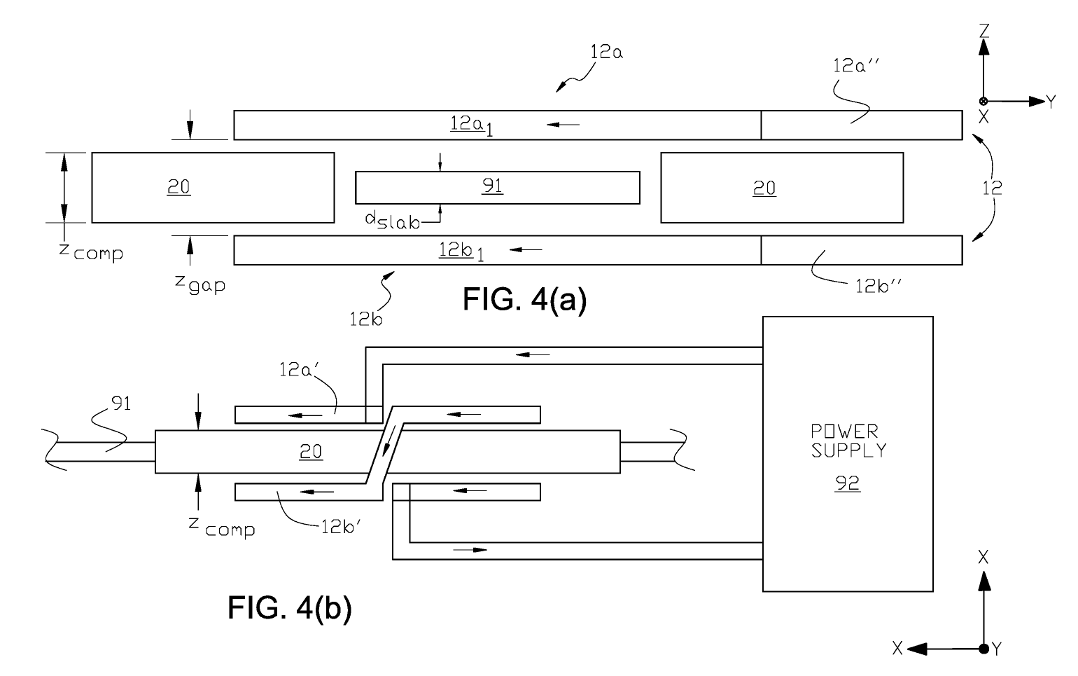

Referring now to the drawings, wherein like numerals indicate like elements, there is shown in FIG. 3, FIG. 4(a), FIG. 4(b), FIG. 4(c) and FIG. 4(d) one example of the slab edge inductive heating apparatus of the present invention.

Slab 91 moves in the X direction between transverse coil segments 12a₁ and 12b₁ of transverse flux coil sections 12a and 12b, respectively, which are disposed above and below the opposing side surfaces of the slab and make up transverse flux inductor (induction coil) 12. The two coil sections are preferably parallel to each other in the Z direction. An electrically conductive compensator 20, formed from a highly conductive material such as a copper composition, is disposed adjacent to opposing edges of the slab within an edge compensator region as further described below. Coil sections 12a and 12b are preferably connected to a single power supply 92 as shown, for example, in FIG. 4(b), so that instantaneous current flows are in the directions indicated by the arrows. While the supply is connected to both coil sections at one end of each coil in FIG. 4(b), other suitable power connection points can be used in other examples of the invention. For example, power connections may be made to each coil section in the transverse coil segments. A single supply is preferred, rather than a separate supply to each coil section, so that magnetic flux symmetry is easily achieved between the upper and lower coil sections. Magnetic flux concentrators 94 (illustrated in FIG. 3 for only one transverse segment 12a₁ of coil section 12a) extend around each transverse coil segment making up the pair of coil sections 12a and 12b. Each of the coil sections has a pair of transverse coil segments separated by a pole pitch distance (x_{c}). Each transverse coil segment extends transversely beyond the transverse edge of the slab as shown, for example, in FIG. 3 for transverse coil segment 12a₁. The extended ends of adjacent transverse coil segments are joined together by a longitudinal coil segment that can be oriented substantially parallel to the length of the slab. For example, as shown in FIG. 3, transverse coil segments 12a₁ are joined together at one pair of adjacent ends by longitudinal coil segment 12a₂. In the embodiment of the invention shown in FIG. 3, the opposing extended ends of transverse coil segments 12a₁ are joined together by a longitudinal coil segment formed from the combination of coil segments 12a′ and 12a″, which, in turn, connect the transverse flux coil sections to the alternating current power supply. Preferably the magnetic flux concentrators extend over each transverse coil segment for at least the entire width of a slab moving between the coil sections to direct the magnetic flux produced by current flow in the coil sections towards the surfaces of slab 91.

Fundamental to the use of the transverse flux coil as an edge heater for a slab formed from a non-ferromagnetic composition in the present invention is that the output frequency, f_{slab} of power supply 92 should be selected so that it is greater than the value determined by the following equation:

$${f}_{slab} > 0.5 \cdot {10}^{7} \cdot ( \frac{{ρ}_{slab}}{{d}_{slab}^{2}} ) \qquad [ equation ( 1 ) ]$$

where ρ_{slab} is the electrical resistivity of the slab material measured in Ωm, and d_{slab} is the thickness of the slab measured in meters.

A range of transverse slab widths can be accommodated by one arrangement of the present invention provided that means 96 (FIG. 3) are provided to move the compensators in the Y (transverse) direction to accommodate changes in the widths of the slab. For example the apparatus for moving the compensators may be linear rails or rods structurally connected to the compensators and attached to the output of one or more linear actuators (or alternatively manually operated).

In one particular example of the invention, slabs having transverse widths (w_{slab}) between 1,000 mm and 2,150 mm, and thicknesses between 30 mm and 60 mm, can be accommodated with the following slab edge inductive heating apparatus of the present invention. Each transverse flux coil section's pitch (x_{c}) for the pair of transverse coil segments is approximately 900 mm, and each coil section's width (y_{c}) is approximately 2,400 mm, with the coil making up each transverse coil section having a width of approximately 240 mm (w_{coil}), when the coil sections are formed as rectangular conductors, as illustrated in FIG. 4(d), with optional interior hollow passage for flow of a cooling medium such as water. As the ratio of the coil pitch to the width of the slab increases, the ratio of power induced in the slab edges to power induced in the remaining transverse cross section of the slab will also increase. Each compensator 20 is formed from an electrically conductive material, such as a copper composition, with a length x_{comp} of approximately 1,300 mm; a width y_{comp} of approximately 900 mm; and a height z_{comp} only slightly less than gap z_{gap} as necessary to prevent short circuiting between the compensator and an adjacent coil section. Distance (gap) z_{gap} between the upper coil section 12a and lower coil section 12b is approximately 250 mm. When the width of the slab is changed, the compensators should be moved in the Y direction to allow a minimum separation y_{gap} between the edge of the slab and the edge of the adjacent compensation. For example a distance of 40 mm for y_{gap} may be satisfactory to allow for weaving of the slab in the Y direction between the compensators. The distance d₁ in FIG. 3 will change from approximately zero to 575 mm as the width of the slab changes from the maximum of 2,150 mm to 1,000 mm, and the compensators are moved in the Y direction to accommodate the various widths. The dimensions of the flux compensator utilized in this example of the invention are selected so that each flux compensator is situated in the edge compensator region established between the extended transverse ends of the transverse coil segments and adjoining longitudinal segment of opposing coil sections 12a and 12b, and adjacent to each slab edge.

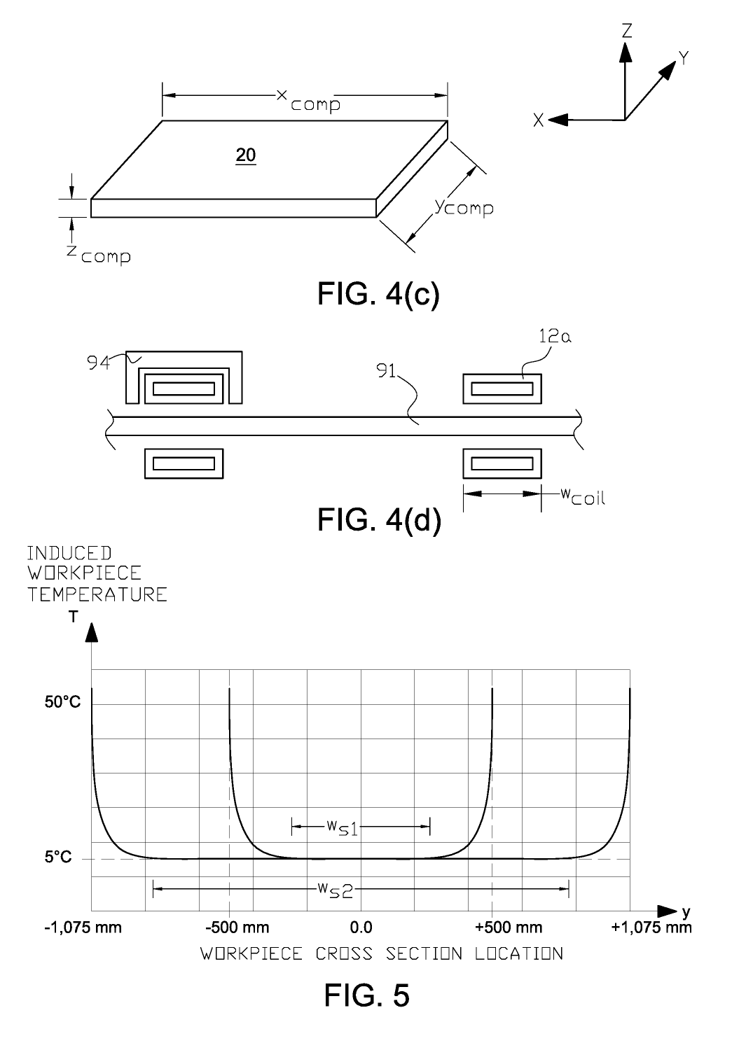

The above relative dimensions of slab, coils and compensators have been found to be the most favorable in achieving slab edge heating with the transverse flux coil arrangement of the present invention with a range of slabs as described above. The above arrangement is extended to other configurations in other examples of the invention. FIG. 5 illustrates two examples of the achievable edge heating with the present invention wherein the extreme edges of a slab with a width of 2,150 mm or 1,000 mm can achieve an induced heating temperature of 50° C. of the slab edges while a nominal temperature rise of 5° C. in the central cross sectional region of the slab will occur. As illustrated in FIG. 5, for the slab with a width of 1,000 mm, the transverse edge of the slab can be inductively heated to ten times (50° C.) the temperature (5° C.) of approximately 65 percent of the interior transverse width (wₛ₁) of the slab with the slab edge inductive heating apparatus of the present invention. For the slab with a width of 2,150 mm, the transverse edge of the slab can be inductively heated to ten times (50° C.) the temperature (5° C.) of approximately 80 percent of the interior transverse width (wₛ₂) of the slab with the slab edge inductive heating apparatus of the present invention.

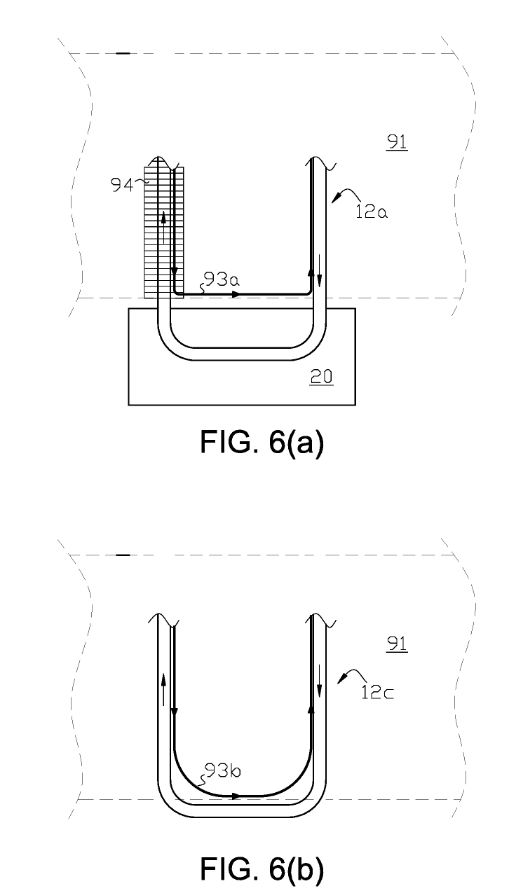

Extending the transverse ends of the transverse flux induction coil used in the present invention maximizes concentration of induced currents in the edge regions of the strip. In FIG. 6(b), with the transverse ends of the coil positioned near a slab's edge, instantaneous induced eddy current flow (represented by line 93b with arrows), and therefore, induced heating, in the extreme edges of the slab is not maximized; however, as in the present invention, with extended transverse coil ends and magnetic flux concentrators, as illustrated in FIG. 6(a), induced eddy current flow (represented by line 93a with arrows) in the extreme edges of the slab is maximized.

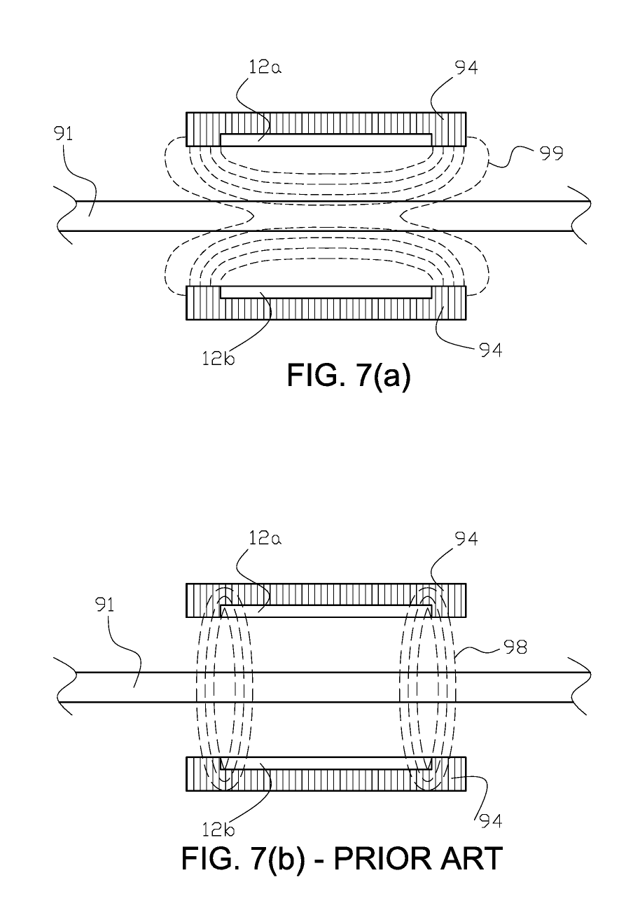

Choosing the operating frequency, f_{slab}, based on the electrical conductivity of the slab material and thickness of the slab results in magnetic flux distribution 99 (dashed lines) as illustrated in FIG. 7(a), which is favorable to edge heating, as opposed to magnetic flux distribution 98 (dashed lines) shown in FIG. 7(b) for the prior art described above. Generally for efficient edge heating in the present invention, the ratio of the thickness of the slab to the standard depth of eddy current penetration is preferably greater than about 3. This is contrasted with the prior art strip heating described about where the standard depth of eddy current penetration is less than the thickness of the strip.

Utilization of the flux compensators between the extended ends of the transverse flux coil (in lieu of air) significantly reduces the impedance of the coil and allows sufficient power to be provided from the power supply for inductive edge heating of the slab.

Each slab moving through the transverse flux coil sections of the transverse flux coil may be of any length.

While a transverse flux inductor having single turn coil sections is used in the above examples of the invention, multiple turn coil sections are utilized in other examples of the invention. While the embodiments of the slab edge inductive heating apparatus and method in the above examples of the invention are used to heat both transverse edges of the slab, in other examples only one of the transverse edges of the slab may be inductively heated.

The present invention has been described in terms of preferred examples and embodiments, and in the appended claims. Equivalents, alternatives and modifications, aside from those expressly stated, are possible and within the scope of the invention. Those skilled in the art, having the benefit of the teachings of this specification, may make modifications thereto without departing from the scope of the invention.

1. A slab edge inductive heating apparatus for inductively heating at least one transverse edge of the slab of an electrically conductive material, the apparatus comprising:
a pair of transverse flux coil sections, each one of the pair of transverse flux coil sections having a pair of transverse coil segments, the pair of transverse coils segments of one of the pair of transverse flux coil sections spaced apart from the pair of transverse coil segments of the other one of the pair of transverse flux coil sections to form a slab induction heating region through which the slab can pass with the length of the slab oriented substantially normal to the pair of transverse coil segments of each one of the pair of transverse flux coil sections, the transverse coil segments for each one of the pair of transverse flux coil sections co-planarly separated from each other by a coil pitch distance, the transverse coil segments of each one of the pair of transverse flux coil sections having an extended transverse ends extending transversely beyond the at least one edge of the slab in the slab induction heating region, the extended transverse ends of the transverse coil segments of each one of the pair of transverse flux coil sections connected together by a separate longitudinal coil segment oriented substantially parallel to the length of the slab in the slab induction heating region, the extended transverse ends and the longitudinal coil segment forming an edge compensator region between the extended transverse ends and the longitudinal coil segment of each one of the pair of transverse flux coil sections;
at least one magnetic flux concentrator surrounding at least the transverse coils segments of the pair of transverse flux coil sections substantially in all directions facing away from the slab induction heating region;
at least one alternating current power source connected to the pair of transverse flux coil sections so that an instantaneous current flows in the same direction through each one of the pair of transverse flux coil sections, each one of the at least one alternating power source having an output frequency, f_{slab}, determined according to the following equation:
$${f}_{slab} > 0.5 \cdot {10}^{7} \cdot ( \frac{{ρ}_{slab}}{{d}_{slab}^{2}} )$$
where ρ_{slab} is the electrical resistivity of the slab and d_{slab} is the thickness of the slab; and
an electrically conductive compensator disposed within the edge compensator region.

2. The slab edge inductive heating apparatus of claim 1 wherein the flux compensator is generally rectangular, the length of the flux compensator greater than the pole pitch distance, the height of the compensator substantially equal to the distance between the extended transverse ends and longitudinal coil segment of the pair of transverse flux coil sections while maintaining electrical isolation between the pair of transverse flux coil sections, the height of the flux compensator greater than the thickness of the slab.

3. The slab edge inductive heating apparatus of claim 1 wherein the at least one transverse edge is inductively heated to a temperature at least ten times as high as the temperature in 65 percent of the interior transverse width of the slab.

4. The slab edge inductive heating apparatus of claim 1 wherein the ratio of the thickness of the slab to the standard depth of induced eddy current penetration is greater than 3.

5. The slab edge inductive heating apparatus of claim 1 further comprising an apparatus for moving the electrically conductive compensator responsive to a change in the transverse width of the slab in the slab induction heating region.
